(19) United States
(12) Patent Application Publication
(10) Pub. No.: US 2026/0166779 A1
(43) Pub. Date: Jun. 18, 2026

(54) GRANULATED PRODUCT AND METHOD FOR PRODUCING SAME

(71) Applicant: KANEKA CORPORATION, Osaka-shi (JP)

(72) Inventor: Ryuki YASUNARI, Takasago-shi (JP)

(73) Assignee: KANEKA CORPORATION, Osaka-shi (JP)

(21) Appl. No.: 19/111,531

(22) PCT Filed: Sep. 8, 2023
(86) PCT No.: PCT/JP2023/032780

§ 371 Date: Mar. 13, 2025

(30) Foreign Application Priority Data
Sep. 26, 2022 (JP) 2022-152921

(51) Int. Cl. B29B 9/08; B01J 2/22; B29K 67/00

(52) U.S. Cl. CPC B29B 9/08; B01J 2/22; B29K 2067/04

(57) ABSTRACT

An object is to provide a granulated product that contains an aliphatic polyester and that has a high bulk density and high flowability. The object is achieved by a method for producing a granulated product that includes aliphatic polyester, the method including the step of performing compression granulation of a powder that contains an aliphatic polyester and that has a bulk density of 0.30 g/cm³ to 0.50 g/cm³.

### TECHNICAL FIELD

The present invention relates to a granulated product and a method for producing the granulated product.

### BACKGROUND ART

A biodegradable resin such as polyhydroxyalkanoate (PHA) has biodegradablity. Thus, use of the biodegradable resin in various applications is progressing. For example, when PHA is used, the PHA is provided, for example, in the form of dried powder, for transportation and/or processing. Conventionally, a method in which a PHA powder is produced by spray drying of a PHA suspension has been developed (for example, Patent Literature 1).

Meanwhile, known is a technique that is a process for preparing a plastic composition which contains at least one polyester, biological entities having a polyester-degrading activity, and at least one anti-acid filler, and in which the biological entities occupy less than 11% (by weight) based on the total weight of the plastic composition, and that carries out a mixing step at a temperature at which the polyester is partially or entirely melted and/or in an extruder, more preferably a biaxial screw extruder, and more preferably a co-rotating biaxial screw extruder (for example, Patent Literature 2).

### CITATION LIST

### Patent Literature

### [Patent Literature 1]

Specification of International Publication No. WO 2018/070492

### [Patent Literature 2]

Japanese Patent Application Publication Tokukai No. 2021-119240

### SUMMARY OF INVENTION

### Technical Problem

However, the PHA powder obtained by the spray drying disclosed in Patent Literature 1 has a low bulk density and may have poor flowability. Therefore, there has been room for improvement.

Further, the technique disclosed in Patent Literature 2 is for performing mixing with use of an extruder, and thus, there has been a problem such as a decrease in molecular weight of an aliphatic polyester.

An object of an aspect of the present invention is to provide a granulated product that contains an aliphatic polyester and that has a high bulk density and high flowability.

### Solution to Problem

In order to solve the above problem, the present inventor made diligent studies. As a result, the inventor has found that an aliphatic polyester having a high bulk density and high flowability can be produced by including a step of performing compression granulation of a powder that contains an aliphatic polyester and that has a bulk density in a specific range. The inventor thus has accomplished the present invention.

Accordingly, an aspect of the present invention is a method for producing a granulated product including an aliphatic polyester (hereinafter, the “method in accordance with an embodiment of the present invention for producing a granulated product that contains an aliphatic polyester” is referred to as “the present production method”), the method including the step of performing compression granulation of a powder that contains the aliphatic polyester and that has a bulk density of 0.30 g/cm³ to 0.50 g/cm³.

Further, another aspect of the present invention is a granulated product (hereinafter, referred to as “the present granulated product”) having a bulk density of more than 0.50 g/cm³ and not more than 0.70 g/cm³ and an aliphatic polyester content of not less than 90% by weight.

### Advantageous Effects of Invention

An aspect of the present invention can provide a granulated product that contains an aliphatic polyester and that has a high bulk density and high flowability.

### DESCRIPTION OF EMBODIMENTS

The following description will discuss an embodiment of the present invention in detail. Note that in the present specification, the wording “A to B” indicative of a numerical range means “A or more and B or less” unless otherwise specifically noted. Further, all literatures described in the present specification are incorporated herein as reference literatures.

### [1. Overview of Present Invention]

A PHA powder obtained by spray drying as disclosed in Patent Literature 1 is subsequently pelletized by, for example, a compounding step. As a result of pelletizing the PHA powder, handleability in feeding to a molding machine improves, and transportability is enhanced due to an increase in apparent bulk density. However, the present inventor has found that the conventional method disclosed in Patent Literature 1 causes the following problem: since the bulk density of a resultant PHA powder is low, the flowability of the PHA powder becomes low, and as a result, production efficiency in, for example, the compounding step decreases. In addition, such low flowability of the PHA powder results in a problem of poor transportability of that powder.

Further, the present inventor has found that in the technique disclosed in Patent Literature 2 using an extruder causes the following problem: in a case where an aliphatic polyester having poor flowability is used, it is difficult to put the aliphatic polyester into the extruder and thus, production speed decreases. Furthermore, the present inventor has found the following problem: in a case where in order to increase the production speed, rotational frequency of a screw(s) of the extruder is increased, the temperature excessively rises, and this results in pyrolysis of the aliphatic polyester and a lower molecular weight. In particular, since the melting point and the decomposition temperature of the above-described PHA are close to each other, the molecular weight of the PHA easily decreases when the PHA is heated to have higher flowability.

In light of the above, the present inventor conducted diligent studies in order to attain the object, and successfully obtained the following findings.
It is possible to obtain a granulated product having a high bulk density and excellent flowability by compression granulation of a powder that contains an aliphatic polyester and that has a low bulk density.
The granulated product obtained by the present production method has a high bulk density, and thus is excellent in transportability.
The present production method makes it possible to produce, without use of a binder, a granulated product containing aliphatic polyester.
The present production method does not require use of, for example, a plasticizer during compression granulation, and thus it is possible obtain a granulated product in which the amount of impurities is small and which has a high aliphatic polyester content.

In particular, since there has not been a technical idea of obtaining a granulated product having a high bulk density by compression granulation of a powder that contains an aliphatic polyester and that has a low bulk density, the present invention is outstanding. Since the present granulated product obtained by the present production method has a high bulk density and excellent flowability, the present granulated product can be advantageously used as a granulated product material containing an aliphatic polyester.

In the present specification, the “powder” is intended to mean a product having a median diameter of less than 0.5 mm. The “granulated product” is intended to mean particles obtained by granulation of a powder and in particular, particles having a median diameter of 0.5 mm to 10.0 mm.

The above-described configuration makes it possible to efficiently produce a plastic product, and thus, it is possible contribute to for to achieving, example, Sustainable Development Goals (SDGs) such as Goal 12 “Ensure sustainable consumption and production patterns” and Goal 14 “Conserve and sustainably use the oceans, seas and marine resources for sustainable development”. The following description will discuss a configuration of the present production method.

### [2. Method for Producing Aliphatic Polyester Granulated Product]

The present production method includes the step of performing compression granulation of a powder that contains an aliphatic polyester and that has a bulk density of 0.30 g/cm³ to 0.50 g/cm³. Having the above configuration, the present production method makes it possible to obtain an aliphatic polyester granulated product that has a high bulk density and excellent flowability.

(2-1. Powder that Contains Aliphatic Polyester)

The powder that contains an aliphatic polyester in the present production method has a bulk density of 0.30 g/cm³ to 0.50 g/cm³. The bulk density of the powder is preferably 0.32 g/cm³ to 0.48 g/cm³, more preferably 0.34 g/cm³ to 0.46 g/cm³, and even more preferably 0.36 g/cm³ to 0.44 g/cm³. The present production method employs a powder that contains an aliphatic polyester having a bulk density in the above range, so that it is possible to obtain an aliphatic polyester granulated product that has a high bulk density and excellent flowability. In the present specification, the bulk density is a value that is measured by a method described in Examples, which will be described later.

The powder contains an aliphatic polyester. The aliphatic polyester is not particularly limited. Examples of the aliphatic polyester include: poly(3-hydroxyalkanoate) (hereinafter, also referred to as “P3HA”), polylactic acid (PLA), polybutylene succinate (PBS), polybutylene succinate adipate, polybutylene adipate terephthalate, polybutylene succinate terephthalate, and polycaprolactone. Among these, the aliphatic polyester is preferably P3HA, from the viewpoint of industrial productivity. The powder may include one or two or more of the above aliphatic polyesters.

The aliphatic polyester contained in the powder preferably contains not less than 50% by weight of P3HA, more preferably contains not less than 60% by weight, more preferably contains not less than 70% by weight, more preferably contains not less than 80% by weight, even more preferably contains not less than 90% by weight, and still more preferably contains not less than 95% by weight, in 100% by weight of the aliphatic polyester. The aliphatic polyester contained in the powder particularly preferably contains 100% by weight of P3HA in 100% by weight of the aliphatic polyester.

The median diameter of the powder is preferably 60 μm to 200 μm, more preferably 80 μm to 180 μm, and even more preferably 100 μm to 170 μm. The yellowness (YI) of the powder is preferably not more than 40, more preferably not more than 35, and even more preferably not more than 30. Note that the lower the YI is, the lower the yellowness is, and accordingly, the lower limit of the YI is not particularly limited. For example, the YI can be not less than 5. The thermal stability of the powder is preferably 70% to 100%, more preferably 75% to 95%, and even more preferably 77% to 85%. The median diameter, the YI, and the thermal stability can be measured by a method described in Examples, which will be described later.

The powder that contains an aliphatic polyester in the present production method includes preferably not less than 90% by weight, more preferably not less than 95% by weight, even more preferably not less than 97% by weight, and most preferably not less than 99% by weight of the aliphatic polyester. The upper limit of the content of the aliphatic polyester in the powder is not particularly limited, and is, for example, not more than 100% by weight. The content may be 100% by weight.

The aliphatic polyester contained in the powder has a melting point of preferably 50° C. to 200° C., more preferably 60° C. to 180° C., even more preferably 70° C. to 170° C., and particularly preferably 80° C. to 160° C. In a case where the melting point of the aliphatic polyester is in the above range, it is possible to fuse the powder without heating during compression granulation and therefore to decrease the amount of a binder used which will be described below.

In an embodiment of the present invention, the powder that contains an aliphatic polyester contains no binder. In the present production method, the granulated product that contains the aliphatic polyester can be produced by including the step of performing, without use of a binder, compression granulation of the powder that contains the aliphatic polyester. In the present specification, the “binder” is intended to refer to a material, such as a plasticizer, cellulose, or water, which bonds or promotes bonding of aliphatic polyesters to each other. Further, in the present specification, the expression “containing no binder” regarding the powder that contains an aliphatic polyester is intended to mean not only a case where the powder that contains an aliphatic polyester contains no binder but also a case where the powder contains substantially no binder. The expression “containing substantially no powder” regarding the powder that contains an aliphatic polyester is intended to mean containing, for example, not more than 1% by weight, more preferably not more than 0.1% by weight, and even more preferably not more than 0.01% by weight of a binder with respect to 100% by weight of the powder that contains an aliphatic polyester. A lower binder content can lead to lower production cost.

The following description will use, as an example of the aliphatic polyester, poly(3-hydroxyalkanoate), and discuss in detail an aspect of the present production method, which includes a method of producing the powder that contains the aliphatic polyester.

### <P3 HA>

The P3HA in the present production method is a polymer having a 3-hydroxyalkanoate unit as a structural unit (monomer unit). In the present specification, “3-hydroxyalkanoate” may also be referred to as “3HA”. As the P3HA, specifically, a polymer that includes a repeating unit represented by general formula (1) is preferable:

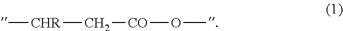

In the general formula (1), R represents an alkyl group expressed as a CₙH₂ₙ₊₁, and n represents an integer of 1 to 15. Examples of R include a linear or branched alkyl group such as a methyl group, an ethyl group, a propyl group, an isopropyl group, a butyl group, an isobutyl group, a t-butyl group, a pentyl group, and a hexyl group. n is preferably 1 to 10, and more preferably 1 to 8.

More specifically, examples of the PHA include poly(3-hydroxybutyrate) (P3HB), poly(3-hydroxybutyrate-co-3-hydroxypropionate) (P3HB3HP), poly(3-hydroxybutyrate-co-3-hydroxyhexanoate) (P3HB3HH), poly(3-hydroxybutyrate-co-3-hydroxyvalerate) (P3HB3HV), poly(3-hydroxybutyrate-co-4-hydroxybutyrate) (P3HB4HB), poly(3-hydroxybutyrate-co-3-hydroxyoctanoate) (P3HB3HO), poly(3-hydroxybutyrate-co-3-hydroxyoctadecanoate) (P3HB3HOD), poly(3-hydroxybutyrate-co-3-hydroxydecanoate) (P3HB3HD), and poly(3-hydroxybutyrate-co-3-hydroxyvalerate-co-3-hydroxyhexanoate) (P3HB3HV3HH). Among these examples, P3HB, P3HB3HH, P3HB3HV, P3HB4HB and P3HB3HP are preferable because they are easy to industrially produce.

Further, P3HB3HH, which is a copolymer of 3-hydroxybutyric acid and 3-hydroxyhexanoic acid, is more preferable from the following viewpoints: (i) by changing a composition ratio of repeating units, it is possible to cause a change in melting point and crystallinity and consequently in physical properties, such as a Young's modulus and heat resistance, of P3HB3HH and to enable P3HB3HH to have physical properties between the physical properties of polypropylene and the physical properties of polyethylene; and (ii) P3HB3HH is a plastic that is easy to industrially produce as described above and has useful physical properties.

More specifically, the P3HA is a copolymer having a 3-hydroxybutyrate unit and a comonomer unit, and the ratio of the 3HB unit to the comonomer unit (the 3HB unit/the comonomer unit) in 100 mol % of all repeating units in the copolymer is preferably 70/30 (mol %/mol %) to 99/1 (mol %/mol %), more preferably 75/25 (mol %/mol %) to 97/3 (mol %/mol %), and even more preferably 80/20 (mol %/mol %) to 95/5 (mol %/mol %).

The P3HA having such a ratio of monomer units can be prepared in accordance with a method known to a person skilled in the art, which is, for example, a method described in International Publication No. WO 2009/145164. The ratio of the monomer units in the P3HA (i.e., the above described (the 3HB unit/the comonomer unit)) can be determined by a method known to a person skilled in the art, which is, for example, the method described in Examples.

<Method for Producing Powder that Contains P3HA>

In an embodiment of the present invention, a method for producing a powder that contains P3HA (hereinafter, which may also be referred to as “P3HA powder”) is not particularly limited, and may be a production method using chemical synthesis or may be a production method using a microorganism. Among such methods, a production method using a microorganism is preferable. For a P3HA production method using a microorganism, a known method can be employed. The P3HA production method preferably includes a culture process, a purification process, and a drying process.

A method for culturing, in the culture process, a microorganism that produces P3HA is not particularly limited, and can be, for example, a method disclosed in International Publication No. WO 2019/142717.

The microorganism that produces P3HA is not particularly limited, provided that the microorganism is capable of producing PHA within a cell of the microorganism. For example, it is possible to use a microorganism isolated from nature, a microorganism deposited at a depositary institution (for example, IFO, ATCC, or the like) for strains, or a mutant, a transformant, or the like that can be prepared from any of those microorganisms. Examples of a bacteria that produces P3HB, which is an example of PHA, include: Bacillus megaterium, which is the first P3HB producing microbial cell that was discovered in 1925; and other natural microorganisms such as Cupriavidus necator (former classification: Alcaligenes eutrophus), Ralstonia eutropha and Alcaligenes latus. It is known that PHA is accumulated in the bodies of these microorganisms.

Further, examples of a bacterium that produces a copolymer of hydroxybutyrate and another hydroxyalkanoate, the copolymer being an example of PHA, include Aeromonas caviae, which is a bacterium capable of producing P3HB3HV and P3HB3HH, and Alcaligenes eutrophus, which is a bacterium capable of producing P3HB4HB. In particular, regarding P3HB3HH, for example, an Alcaligenes eutrophus AC32 strain (Alcaligenes eutrophus AC32, FERM BP-6038) (T. Fukui, Y. Doi, J. Bateriol., 179, p. 4821-4830 (1997)) into which genes of a group of PHA synthases have been introduced to increase productivity of P3HB3HH is more preferable. Further, the bacteria may be, besides the above, a genetically modified microorganism into which various PHA synthesis-related genes have been introduced may be used in accordance with PHA that is desired to be produced.

A method for purifying P3HA obtained by microbial culture in the purification process is not particularly limited, and a known physical treatment, and/or a known chemical treatment, and/or a known biological treatment may be employed. For example, a purification method described in International Publication No. WO 2010/067543 may be preferably employed.

A method for subjecting the P3HA obtained by microbial culture and purification to drying in the drying process is not particularly limited, and spray drying, fluidized bed drying, airflow drying, rotational drying, vibrational drying, band drying, and plate drying can be employed. For example, a drying method described in International Publication No. WO 2018/070492 may be preferably employed.

Examples of a spray-drying method include a method in which an aqueous suspension containing P3HA (hereinafter, referred to as “P3HA aqueous suspension”) in a state of fine droplets is supplied into a dryer and dried in contact with hot air in the dryer. A method (atomizer) of supplying the P3HA aqueous suspension in a state of fine droplets into a dryer is not particularly limited, and can be a known method such as a method using a rotary disc or a method using a nozzle. A manner of contact between the droplets and the hot air in the dryer is not particularly limited. For example, the droplets and the hot air can be brought in contact with each other in a co-current manner, a countercurrent manner, or in a manner combining the co-current manner and the countercurrent manner.

A drying temperature in the spray-drying may be any temperature at which most of an aqueous medium can be removed from the droplets of the P3HA aqueous suspension. The drying temperature can be set as appropriate, provided that the P3HA aqueous solution can be dried until a desired moisture content is achieved and that a deterioration in quality (a decrease in molecular weight and a reduction in color tone) and melting are minimized. In addition, a volume of hot air in the dryer can be set as appropriate, for example, in accordance with a size of the dryer and the like.

The method for producing P3HA powder may include, after the spray drying, a step of further drying resulting P3HA. The method for producing P3HA may include another step(s) (for example, a step of adding various additives to the P3HA aqueous suspension).

### (2-2. Compression Granulation Step)

The present production method includes the step of carrying out compression granulation of a powder that contains the above-described aliphatic polyester (hereinafter, also referred to as “compression granulation step”). Compression granulation of the powder makes it possible to obtain a granulated product which contains an aliphatic polyester and which has a high bulk density and excellent flowability. Enhancement of the flowability of the granulated product can make a phenomenon called “feedneck” unlikely to occur (in the phenomenon, a material (powder that contains the aliphatic polyester in the present production method) fed to a device is pushed back by a material that has been already fed). This consequently improves production efficiency of the product. Furthermore, the step of performing compression granulation makes granulation possible even in a case where the powder does not contain a binder described above. Therefore, the step of performing compression granulation consequently makes it possible to decrease production cost.

The present inventor infers that the granulated product which contains aliphatic polyesters and which has a high bulk density is obtained by the compression granulation step because the aliphatic polyesters are fused to each other by heat (friction force) generated and are hardened in the compression granulation step. In this way, the present production method makes it possible to solidify a powder without heating, and thus, it becomes unnecessary to use the above-described binder. This also has an advantage of making it possible to decrease the production cost.

In the compression granulation step, compression is carried out at a pressure of preferably 10 kN to 60 kN, more preferably 15 kN to 50 kN, and even more preferably 17 kN to 47 kN. In a case where the pressure is not less than 10 kN, it is possible to sufficiently fuse the powder. On the other hand, in a case where the pressure is not more than 60 kN, it is possible to make torque over of a granulation machine unlikely to occur and to prevent the material from melting completely.

In the present production method, a granulated product that has a high bulk density can be produced without heating in the compression granulation step. Thus, in an embodiment of the present invention, the compression granulation step is carried out at preferably not higher than 50° C., more preferably at not higher than 40° C., and even more preferably at not higher than 30° C. Note also that the lower limit of temperature is not particularly limited, but may be, for example, not less than 0° C. In a case where the compression granulation step is carried out within the above temperature range, pyrolysis of the aliphatic polyester is unlikely to occur. Therefore, a decrease in molecular weight of the aliphatic polyester can be suppressed.

The temperature of the material in the compression granulation step is not particularly limited. The temperature of the material may be, for example, 0° C. to 100° C. The material may be heated or may be non-heated. That is, the present production method makes it possible to granulate the powder, regardless of the temperature of the material. It is preferable that the material be not heated, from the viewpoint that pyrolysis of the aliphatic polyester is unlikely to occur.

In the present production method, a method of performing the compression granulation is not particularly limited, and can be carried out, for example, with use of a known compression granulation device. The compression granulation device is not particularly limited in type. Examples of the type of the compression granulation device include a plate type, a tablet type, a briquette type, a compacting type, a screw extrusion type, a roll foot extrusion type, a blade extrusion type, a mobile dice type, and a ram extrusion type. Among these, it is preferable that the compression granulation device be a briquette-type granulator, from the viewpoint of achieving both good quality and productivity of the granulated product which contains an aliphatic polyester. As the briquette-type granulator, it is possible to use a briquetting machine (manufactured by HOSOKAWA MICRON CORPORATION), Buricatta (registered trademark) BSS (manufactured by SHINTOKOGIO LTD.), BM-2 (KEIHAN CO., LTD.), and the like.

A method of feeding, to the compression granulation device, the powder which is a material is not particularly limited. For example, the powder can be stored in a hopper and directly fed to the granulation device by a transfer conveyor which is an accessory of the hopper, or alternatively, the powder can be fed to the compression granulation device from a hopper transfer conveyer via a belt conveyer, a bucket conveyer, or the like.

In a briquette-type compression granulation device, the granulated product is produced by: vertically pushing in, with use of a screw, the powder fed, and compressing, from left and right with use of a pair of rollers, the powder thus pushed in. Examples of a type of the rollers include ring rolls, segmental rolls, and compact rolls.

In a case where the briquette-type compression granulation device is used, rotational frequency of the rolls is preferably 5 rpm to 20 rpm, more preferably 7 rpm to 15 rpm, and even more preferably 10 rpm to 14 rpm. Compression force is preferably 10 kN to 60 kN, more preferably 15 kN to 50 kN, and even more preferably 17 kN to 47 kN. Roll support pressure is preferably 3 MPa to 15 MPa, more preferably 4 MPa to 10 MPa, and even more preferably 4.5 MPa to 9 MPa.

The compression granulation step may be carried out separately by a step of compression and a step of crushing (granulation). That is, after compression of the powder, granulation may be performed by crushing the powder. Specifically, after a compressed sheet containing the aliphatic polyester is produced by, for example, compression of the powder, the compressed sheet may be crushed.

In an embodiment of the present invention, the compression granulation step may include the following steps:
(a) the step of obtaining a sheet-like aliphatic polyester by compression of the powder that contains the aliphatic polyester and that has a bulk density of 0.30 g/cm³ to 0.50 g/cm³; and
(b) the step of crushing the sheet-like aliphatic polyester obtained in the (a).

A method of carrying out the above crushing step is not particularly limited, provided that a compressed and granulated product obtained can be crushed. Further, the method can be carried out by a known crusher. Examples of a device that can be used for the step of crushing include: various crushers, such as a jaw crasher, a roll crusher, and a flake crusher; various mills such as a roller mill, a cutting mill, and a cutter mill; and a vibrating sieve in which a crushed medium is added. It is also possible to use a combination of these crushers. As the flake crusher, for example, a feature mill (manufactured by HOSOKAWA MICRON CORPORATION) and a Rotoplex (manufactured by HOSOKAWA MICRON CORPORATION) can be used.

The present production method may further include, as necessary, the steps of sizing and classifying the granulated product obtained. The step of sizing using a sizing device and the step of classifying using a classifier can be carried out by known methods.

A method for transporting the powder and the granulated product in each of the above steps is not limited. It is possible to use, as the method, natural fall, conveyor transportation, air blowing, or the like. For example, it is preferable to use a method in which the material is transported to a granulator by conveyor transportation and then transported by natural fall into a crusher, a sizing device, and/or a classifier.

(3. Granulated Product that Contains Aliphatic Polyester)

The present granulated product has a bulk density of more than 0.50 g/cm³ and not more than 0.70 g/cm³ and an aliphatic polyester content of not less than 90% by weight. In a case where the present granulated product has the above configuration, flowability, transportability, and the like are enhanced. Note that, with regard to the “aliphatic polyester”, matters described in [2. Method for producing aliphatic polyester granulated product] can be incorporated as appropriate.

The bulk density of the present granulated product is more than 0.50 g/cm³ and not more than 0.70 cm³, preferably 0.51 g/cm³ to 0.65 g/cm³, more preferably 0.52 g/cm³ to 0.60 g/cm³, and even more preferably 0.53 g/cm³ to 0.57 g/cm³. In a case where the bulk density of the present granulated product is within the above range, the present granulated product has excellent flowability and excellent transportability.

The content of the aliphatic polyester in the present granulated product is not less than 90% by weight, preferably not less than 95% by weight, more preferably not less than 97% by weight, and even more preferably not less than 99% by weight. In a case where the content of the aliphatic polyester in the present granulated product is in the above range, processability is excellent. The upper limit of the content of the aliphatic polyester in the present granulated product is not particularly limited, and may be, for example, 100%.

The median diameter of the present granulated product is preferably 0.5 mm to 4.0 mm, more preferably 0.7 mm to 3.8 mm, even more preferably 1.0 mm to 3.5 mm, and particularly preferably 1.3 mm to 3.2 mm. In a case where the median diameter of the present granulated product is not less than 0.5 mm, the flowability of the present granulated product is enhanced. In a case where the median diameter of the present granulated product is not more than 4.0 mm, clogging in a pipe or the like is suppressed. Then, the granulated product can be easily seized by a screw of, for example, an extruder during processing. Accordingly, the productivity can be enhanced. The median diameter of the granulated product can be measured by a method described in Examples, which will be described later.

The present granulated product has a hardness of preferably 5 kgf to 35 kgf, more preferably 7 kgf to 30 kgf, and even more preferably 10 kgf to 25 kgf. In a case where the hardness of the present granulated product is not less than 5 kgf, transportability and flowability are enhanced because damage during transportation can be suppressed. On the other hand, in a case where the hardness of the present granulated product is not more than 35 kgf, the present granulated product can be easily crushed by, for example, a screw and thus the processability is excellent. The hardness of the granulated product can be measured by a method described in Examples, which will be described later.

The moisture content of the present granulated product is preferably not more than 5%, more preferably not more than 1%, even more preferably not more than 0.5%, and particularly preferably not more than 0.3%. A lower moisture content is better, and the moisture content may be, for example, 0%. In a case where the moisture content of the present granulated product is in the above range, the hardness and flowability of the granulated product obtained are enhanced.

The yellowness (YI) of the present granulated product is preferably not more than 40, more preferably not more than 35, and even more preferably not more than 30. Note that the lower the YI is, the lower the yellowness is, and accordingly, the lower limit of the YI is not particularly limited. For example, the YI can be not less than 5. In a case where the YI of the present granulated product is in the above-described range, it can be determined by evaluation that contamination of impurities is kept below a certain amount, and a certain quality can be ensured. The YI can be measured by a method described in Examples, which will be described later.

The thermal stability of the present granulated product is, for example, not less than 70%, preferably not less than 73%, and more preferably not less than 75%. In a case where the thermal stability is within the above range, the present granulated product can be used as a granulated product material having excellent thermal stability. A higher thermal stability is better, and the thermal stability may be, for example, 100%.

In an embodiment of the present invention, the present granulated product is produced by the present production method.

The present granulated product can be used in various applications, such as paper, films, sheets, tubes, plates, rods, containers (e.g., bottle containers), bags, and parts.

The present invention is not limited to the embodiments, but can be altered by a skilled person in the art within the scope of the claims. The present invention also encompasses, in its technical scope, any embodiment derived by combining technical means disclosed in differing embodiments.

In other words, an embodiment of the present invention encompasses the following.

<1> A method for producing a granulated product including an aliphatic polyester, the method including the step of performing compression granulation of a powder that contains the aliphatic polyester and that has a bulk density of 0.30 g/cm³ to 0.50 g/cm³.
<2> The method according to <1>, wherein the step of performing the compression granulation is carried out at not higher than 50° C.
<3> The method according to <1> or <2>, wherein the step of performing the compression granulation is carried out with use of a briquette-type granulator.
<4> The method according to any one of <1> to <3>, wherein in the step of performing the compression granulation, compression is carried out at a pressure of 10 kN to 60 kN.
<5> The method according to any one of <1> to <4>, wherein the aliphatic polyester is poly(3-hydroxyalkanoate).
<6> The method according to any one of <1> to <5>, wherein the aliphatic polyester is at least one selected from the group consisting of poly(3-hydroxybutyrate), poly(3-hydroxybutyrate-co-3-hydroxypropionate), poly(3-hydroxybutyrate-co-3-hydroxyhexanoate), poly(3-hydroxybutyrate-co-3-hydroxyvalerate), and poly(3-hydroxybutyrate-co-4-hydroxybutyrate.
<7> A granulated product containing an aliphatic polyester, the granulated product having a bulk density of more than 0.50 g/cm³ and not more than 0.70 g/cm³ and an aliphatic polyester content of not less than 90% by weight.
<8> The granulated product according to <7>, wherein the aliphatic polyester is poly(3-hydroxyalkanoate).
<9> The granulated product according to <7> or <8>, wherein the aliphatic polyester is at least one selected from the group consisting of poly(3-hydroxybutyrate), poly(3-hydroxybutyrate-co-3-hydroxypropionate), poly(3-hydroxybutyrate-co-3-hydroxyhexanoate), poly(3-hydroxybutyrate-co-3-hydroxyvalerate), and poly(3-hydroxybutyrate-co-4-hydroxybutyrate.
<10> The granulated product according to any one of <7> to <9>, having a median diameter of 0.5 mm to 4.0 mm.
<11> The granulated product according to any one of <7> to <10>, having a hardness of 5 kgf to 35 kgf.
<12> The granulated product according to any one of <7> to <11>, having a moisture content of not more than 5%.

### EXAMPLES

The following description will discuss embodiments of the present invention in further detail on the basis of Examples. Note, however, that the present invention is not limited to the Examples.

### [Measurement Methods]

### (Moisture Content)

The moisture content of each of an aliphatic polyester powder and a granulated product was measured by using a heating and drying method moisture analyzer (product name: MS-70, manufactured by A&D Co., Ltd.).

### [Composition Ratio]

A composition ratio of a 3HB unit and a comonomer unit ((the 3HB unit/the comonomer unit) described above) of an aliphatic polyester (copolymer) in the aliphatic polyester powder was calculated as below. A methyl ester which was a PHA degradation product was obtained by: adding 1 ml of a mixed solution of sulfuric acid and methanol (15:85) and 1 ml of chloroform to 20 mg of dried cultured bacteria which had been prepared for producing the aliphatic polyester powder; tightly sealing a resultant mixture; and heating the resultant mixture at 100° C. 140 minutes. After the resultant mixture was cooled, 0.5 ml of deionized water was added to the resultant mixture and well-mixed, and a moisture thus obtained was left to stand until a water layer and an organic layer were separated from each other. Thereafter, monomer unit composition of the PHA degradation product in the organic layer which had been separated and taken was analyzed by capillary gas chromatography. A gas chromatograph used was GC-17A of Shimadzu Corporation, and a capillary column used was NEUTRA BOND-1 (column length: 25 m, column inner diameter: 0.25 mm, and liquid film thickness: 0.4 μm) manufactured by GL Sciences Inc. A carrier gas used was He, a column entrance pressure was set to 100 kPa, and 1 μl of a sample was injected. As to temperature conditions, the temperature was increased from initial temperature 50° C. to 200° C. at a rate of 8° C./min, and further increased from 200° C. to 290° C. at a rate of 30° C./min.

### (Yellowness)

The yellowness (YI) of each of the aliphatic polyester powder and the granulated product was measured in compliance with JIS K 7373 by using a spectrophotometer (product name: CM-5, manufactured by KONICA MINOLTA, INC.).

### (Molecular Weight)

The weight average molecular weight of the aliphatic polyester in each of the aliphatic polyester powder and the granulated product was measured as a polystyrene equivalent weight average molecular weight by gel permeation chromatography (GPC) (“Shodex GPC-101” manufactured by Showa Denko K.K.) in which a polystyrene gel (“Shodex K-804” manufactured by Show Denko K. K.) was used in a column and chloroform was used as a mobile phase.

### (Bulk Density)

The bulk density of each of the aliphatic polyester powder and the granulated product was measured in compliance with JIS K 7365:1999 by using a bulk density measuring instrument (product name: Standard Bulk Density Measurement Instrument, manufactured by Kuramochi Kagaku Kikai).

### (Hardness)

The hardness of the aliphatic polyester granulated product was measured by using a hardness meter (product name: Kiya Hardness Meter, manufactured by FUJIWARA SCIENTIFIC CO., LTD.).

### (Median Diameter of Aliphatic Polyester Powder)

The median diameter of the aliphatic polyester powder was measured by using a laser diffraction/scattering type particle size distribution measurement device LA-950 (manufactured by HORIBA, Ltd.) To 20 mL of ion-exchange water, 0.05 g of sodium dodecyl sulfate was added as a surfactant, so that an aqueous surfactant solution was obtained. Subsequently, to the aqueous surfactant solution, 0.2 g of the aliphatic polyester powder to be measured was added. Then, the aliphatic polyester powder was dispersed in the aqueous surfactant solution, so that a dispersion slurry for measurement was obtained. The dispersion slurry prepared was introduced into the laser diffraction/scattering type particle size distribution measurement device, and was measured.

### (Median Diameter of Granulated Product)

The median diameter of the aliphatic polyester granulated product was measured in compliance with JIS Z 8801-1:2000, by using a metal mesh sieve.

### (Thermal Stability)

The thermal stability of each of the aliphatic polyester powder and the granulated product was measured by using a small heat press machine (product name: H300-01, manufactured by AS ONE CORPORATION). Pressing was performed at 160° C. and at 13 MPa for 20 minutes, and a ratio at which the molecular weight changed before and after heating was defined as thermal stability.

### (Flowability)

The flowability of each of the aliphatic polyester powder and the granulated product was measured by using an extruder TEM26SS (manufactured by Toshiba Machine Co., Ltd.). A certain amount of powder or granulated product was fed to the extruder, and the number of rotations of a screw before the occurrence of feedneck was measured. Further, a processing amount per given number of rotations was calculated and compared. The flowability was thus evaluated.

### Example 1

### (Compression Granulation)

A P3HB3HH powder (dry powder) that had a 3HH (comonomer unit) ratio shown in Table 1 was obtained by a method disclosed in Example 1 of International Publication No. WO 2021/085534. The powder thus obtained was fed to a briquetting machine (manufactured by HOSOKAWA MICRON CORPORATION) which was a briquette-type granulator that had a vertical screw and two rotating rolls. Then, the powder fed was compressed, so that a compressed sheet was obtained. The compressed sheet obtained was granulated by crushing by a feature mill (manufactured by HOSOKAWA MICRON CORPORATION) which included a vertical screw and a rotating roll, so that a granulated product was obtained. That compression granulation machine was set to have a rotational frequency of the rolls of 14 rpm, a compression force of 40 kN, and a roll support pressure of 9 MPa. Further, the granulated product was produced at room temperature (23° C.) and a material was at a temperature of 22° C. The granulated product had a moisture content of 0.21%, a molecular weight of 420,000, a bulk density of 0.57, a median diameter of 1.8 mm, a YI of 14, a hardness of 10 kgf, a thermal stability of 85%, and a P3HB3HH content of 99% by weight.

### Example 2

A P3HB3HH powder (dry powder) that had a 3HH (comonomer unit) ratio shown in Table 1 was obtained by a method disclosed in Example 1 of International Publication No. WO 2022/091685. The powder thus obtained was fed to the briquetting machine (manufactured by HOSOKAWA MICRON CORPORATION), and a compressed sheet was obtained. The compressed sheet obtained was crushed by the feature mill (manufactured by HOSOKAWA MICRON CORPORATION), so that a granulated product was obtained. That compression granulation machine was set to have a rotational frequency of the rolls of 10 rpm, a compression force of 17 kN, and a roll support pressure of 4.5 MPa. Further, the granulated product was produced at room temperature (23° C.) and a material was at a temperature of 22° C. The granulated product had a moisture content of 0.09%, a molecular weight of 650,000, a bulk density of 0.53, a median diameter of 3.2 mm, a YI of 26, a hardness of 18 kgf, a thermal stability of 77%, and a P3HB3HH content of 99% by weight.

### Example 3

A P3HB3HH powder (dry powder) that had a 3HH ratio shown in Table 1 was obtained as in Example 1 except that a bacteria culture method was changed to a method disclosed in Example 2 of International Publication No. WO 2019/142845. The powder thus obtained was fed to the briquetting machine (manufactured by HOSOKAWA MICRON CORPORATION), and a sheet was obtained. The sheet obtained was crushed by a feature mill (manufactured by HOSOKAWA MICRON CORPORATION) which included a vertical screw and rotating rolls, so that a granulated product was obtained. That compression granulation machine was set to have a rotational frequency of the rolls of 14 rpm, a compression force of 45 kN, and a roll support pressure of 9 MPa. Further, the granulated product was produced at room temperature (23° C.) and a material was at a temperature of 22° C. The granulated product had a moisture content of 0.20%, a molecular weight of 650,000, a bulk density of 0.53, a median diameter of 3.2 mm, a hardness of 14 kgf, a thermal stability of 55%, and a P3HB3HH content of 99% by weight.

### Example 4

A P3HB3HH powder (dry powder) that had a 3HH ratio shown in Table 1 was obtained as in Example 1 except that a bacteria culture method was changed to the method disclosed in Example 2 of International Publication No. WO 2019/142845. The powder thus obtained was fed to the briquetting machine (manufactured by HOSOKAWA MICRON CORPORATION), and a sheet was obtained. The sheet obtained was crushed by a Rotoplex (manufactured by HOSOKAWA MICRON CORPORATION), which included stationary and rotating blades, so that a granulated product was obtained. That compression granulation machine was set to have a rotational frequency of the rolls of 10.7 rpm, a compression force of 25 kN, and a roll support pressure of 4.5 MPa. Further, the granulated product was produced at room temperature (27° C.) and a material was at a temperature of 26° C. The granulated product had a moisture content of 0.09%, a molecular weight of 650,000, a bulk density of 0.54, a median diameter of 2.8 mm, a YI of 26, a hardness of 20 kgf, a thermal stability of 80%, and a P3HB3HH content of 99% by weight.

### Example 5

A dispersion slurry was obtained by the same method as in Example 1 of International Publication No. WO 2022/091685 up to (Cleaning 2) of Example 1. The dispersion slurry was dehydrated through a filter cloth and then with use of a plate dryer (manufactured by Andritz), so that a P3HB3HH powder (dry powder) that had a 3HH ratio shown in Table 1 was obtained. The powder thus obtained was fed to the briquetting machine (manufactured by HOSOKAWA MICRON CORPORATION), and a sheet was obtained. The sheet obtained was crushed by a Rotoplex (manufactured by HOSOKAWA MICRON CORPORATION), which included stationary and rotating blades, so that a granulated product was obtained. That compression granulation machine was set to have a rotational frequency of rolls of 11.5 rpm, a compression force of 36 kN, and a roll support pressure of 9 MPa. Further, the granulated product was produced at room temperature (28° C.) and a material was at a temperature of 28° C. The granulated product had a moisture content of 0.17%, a molecular weight of 450,000, a bulk density of 0.57, a median diameter of 2.5 mm, a YI of 14, a hardness of 14 kgf, a thermal stability of 83%, and a P3HB3HH content of 99% by weight.

### Example 6

A dispersion slurry was obtained by the same method as in Example 1 of International Publication No. WO 2022/091685 up to (Cleaning 2) of Example 1. The dispersion slurry was dehydrated through a filter cloth and then with use of a plate dryer (manufactured by Andritz), so that a P3HB3HH powder (dry powder) that had a 3HH ratio shown in Table 1 was obtained. The powder thus obtained was fed to the briquetting machine (manufactured by HOSOKAWA MICRON CORPORATION), and a sheet was obtained. The sheet obtained was crushed by a Rotoplex (manufactured by HOSOKAWA MICRON CORPORATION), which included stationary and rotating blades, so that a granulated product was obtained. That compression granulation machine was set to have a rotational frequency of rolls of 14.4 rpm, a compression force of 13 kN, and a roll support pressure of 4.1 MPa. Further, the granulated product was produced at room temperature (11° C.) and a material was at a temperature of 60° C. The granulated product had a moisture content of 0.28%, a molecular weight of 700,000, a bulk density of 0.52, a median diameter of 2.5 mm, a YI of 23, a hardness of 24 kgf, a thermal stability of 83%, and a P3HB3HH content of 99% by weight.

### Comparative Example 1

The powder (dry powder) of Example 1 was used as Comparative Example 1. The powder of Comparative Example 1 contained 3HH as a comonomer, and had a moisture content of 0.21%, a (3HB unit/3HH unit) ratio of 94.8/5.2 (mol %/mol %), a weight average molecular weight of 420,000, a bulk density of 0.42, a median diameter of 163 μm, a YI of 14, and a thermal stability of 84%.

### Comparative Example 2

The powder (dry powder) of Example 2 was used as Comparative Example 2. The powder of Comparative Example 2 contained 3HH as a comonomer, and had a moisture content of 0.09%, a (3HB unit/3HH unit) ratio of 82/18 (mol %/mol %), a weight average molecular weight of 650,000, a bulk density of 0.44, a median diameter of 163 μm, a YI of 26, and a thermal stability of 77%.

### Comparative Example 3

The powder (dry powder) of Example 3 was used as Comparative Example 3. The powder of Comparative Example 3 contained 3HH as a comonomer, and had a moisture content of 0.20%, a (3HB unit/3HH unit) ratio of 96.3/3.7 (mol %/mol %), a weight average molecular weight of 330,000, a bulk density of 0.36, a median diameter of 113 μm, and a thermal stability of 55%.

### Comparative Example 4

The powder (dry powder) of Example 4 was used as Comparative Example 4. The powder of Comparative Example 4 contained 3HH as a comonomer, and had a moisture content of 0.09%, a (3HB unit/3HH unit) ratio of 82/18 (mol %/mol %), a weight average molecular weight of 650,000, a bulk density of 0.44, a median diameter of 163 μm, a YI of 26, and a thermal stability of 77%.

### Comparative Example 5

The powder (dry powder) of Example 5 was used as Comparative Example 5. The powder of Comparative Example 5 contained 3HH as a comonomer, and had a moisture content of 0.17%, a (3HB unit/3HH unit) ratio of 94.9/5.1 (mol %/mol %), a weight average molecular weight of 450,000, a bulk density of 0.32, a median diameter of 2.9 μm, a YI of 14, and a thermal stability of 83%.

### Comparative Example 6

The powder (dry powder) of Example 6 was used as Comparative Example 6. The powder of Comparative Example 6 contained 3HH as a comonomer, and had a moisture content of 0.28%, a (3HB unit/3HH unit) ratio of 87.5/12.5 (mol %/mol %), a weight average molecular weight of 700,000, a bulk density of 0.35, a median diameter of 26.1 μm, a YI of 23, and a thermal stability of 83%.

Table 1 shows physical properties of the granulated products of Examples 1 to 6 and the powders of Comparative Examples 1 to 6. Note that the powders of Comparative Examples 1 to 6 were so soft as to be crushed with a hand, and thus the hardness was not measured.

TABLE 1

| | Example | Example | Example | Example | Example | Example |
|---|---|---|---|---|---|---|
| | 1 | 2 | 3 | 4 | 5 | 6 |
| Moisture | 0.21 | 0.09 | 0.20 | 0.09 | 0.17 | 0.28 |
| content | | | | | | |
| (%) | | | | | | |
| 3HH unit | 5.2 | 18 | 3.7 | 18 | 5.1 | 12.5 |
| (mol %) | | | | | | |
| Molecular | 420,000 | 650,000 | 330,000 | 650,000 | 450,000 | 700,000 |
| weight | | | | | | |
| Bulk | 0.57 | 0.53 | 0.55 | 0.54 | 0.57 | 0.52 |
| Density | | | | | | |
| (g/cm³) | | | | | | |
| Median | 1.8 mm | 3.2 mm | 1.3 mm | 2.8 mm | 2.5 mm | 2.8 mm |
| diameter | | | | | | |
| YI | 14.5 | 27.5 | — | 26 | 14 | 23 |
| Hardness | 10 | 18 | 23 | 20 | 14 | 24 |
| (kgf) | | | | | | |
| Thermal | 85 | 77 | 55 | 80 | 83 | 83 |
| stability | | | | | | |
| (%) | | | | | | |
| | Comparative | Comparative | Comparative | Comparative | Comparative | Comparative |
| | Example 1 | Example 2 | Example 3 | Example 4 | Example 5 | Example 6 |
| Moisture | 0.21 | 0.09 | 0.20 | 0.20 | 0.17 | 0.28 |
| content | | | | | | |
| (%) | | | | | | |
| 3HH unit | 5.2 | 18 | 3.7 | 3.7 | 5.1 | 12.5 |
| (mol %) | | | | | | |
| Molecular | 420,000 | 650,000 | 330,000 | 330,000 | 450,000 | 700,000 |
| weight | | | | | | |
| Bulk | 0.42 | 0.44 | 0.36 | 0.36 | 0.32 | 0.35 |
| Density | | | | | | |
| (g/cm³) | | | | | | |
| Median | 163 μm | 163 μm | 113 μm | 113 μm | 2.9 μm | 26.1 μm |
| diameter | | | | | | |
| YI | 14.4 | 27.6 | — | — | 14 | 23 |
| Hardness | — | — | — | — | — | — |
| (kgf) | | | | | | |
| Thermal | 84 | 77 | 55 | 55 | 83 | 83 |
| stability | | | | | | |
| (%) | | | | | | |

Table 2 shows results of flowability tests in Examples 1 and 3 and Comparative Examples 1 and 3. In Table 2, “FN” means feedneck.

TABLE 2

| | | | Comparative | Comparative |
|---|---|---|---|---|
| | Example 1 | Example 3 | Example 1 | Example 3 |
| Feeder supply | 10 ± 0.02 | 10 ± 0.02 | 10 ± 0.02 | 10 ± 2 |
| amount [kg/hr] | | | | (unstable) |
| Maximum number | 63 | 63 | 83 | 100 |
| of rotations at which | | | | |
| FN occurs [rpm] | | | | |
| Processing amount | 0.15 | 0.15 | 0.12 | 0.09 |
| Q/N [kg/rev] | | | | |

### [Results]

According to Table 1, all of the granulated products of Examples 1 to 6 had a bulk density of more than 0.50 g/cm³, and had a higher bulk density than the powders of Comparative Examples 1 to 6. Further, according to Table 2, as compared with the powders of Comparative Examples 1 and 3, the granulated products of Examples 1 and 3 each had a lower number of rotations of the screw(s) at which FN occurs, and an enhanced processing amount. Therefore, it is clear that the granulated products of Examples 1 and 3 had excellent flowability. Further, there was no significant change in thermal stability and YI between the above Examples and the above Comparative Examples. Therefore, it was demonstrated that the granulated product according to an embodiment of the present invention which was produced by compression granulation did not differ from the dry powder produced by spray drying in terms of quality. The above shows that the production method in accordance with an embodiment of the present invention can make it possible to produce a granulated product that contains an aliphatic polyester and that has a high bulk density and high flowability.

### INDUSTRIAL APPLICABILITY

A granulated product obtained by a production method in accordance with an embodiment of the present invention can be suitably used in the fields of agriculture, fishing, forestry, horticulture, medicine, sanitary products, clothing, non-clothing, packaging, automobiles, building materials, and the like.

1. A method for producing a granulated product comprising an aliphatic polyester, the method comprising:
performing compression granulation of a powder that comprises the aliphatic polyester and that has a bulk density of from 0.30 g/cm³ to 0.50 g/cm³.

2. The method according to claim 1, wherein the performing the compression granulation is carried out at 50° C. or less.

3. The method according to claim 1, wherein the performing the compression granulation is carried out using a briquette-type granulator.

4. The method according to claim 1, wherein in the performing the compression granulation, compression is carried out at a pressure of from 10 kN to 60 kN.

5. The method according to claim 1, wherein the aliphatic polyester is poly(3-hydroxyalkanoate).

6. The method according to claim 5, wherein the aliphatic polyester is at least one selected from the group consisting of poly(3-hydroxybutyrate), poly(3-hydroxybutyrate-co-3-hydroxypropionate), poly(3-hydroxybutyrate-co-3-hydroxyhexanoate), poly(3-hydroxybutyrate-co-3-hydroxyvalerate), and poly(3-hydroxybutyrate-co-4-hydroxybutyrate).

7. A granulated product comprising an aliphatic polyester,
wherein the granulated product has a bulk density of more than 0.50 g/cm³ to 0.70 g/cm³, an aliphatic polyester content of at least 90% by weight, and a median diameter of from 0.5 mm to 4.0 mm.

8. The granulated product according to claim 7, wherein the aliphatic polyester is poly(3-hydroxyalkanoate).

9. The granulated product according to claim 8, wherein the aliphatic polyester is at least one selected from the group consisting of poly(3-hydroxybutyrate), poly(3-hydroxybutyrate-co-3-hydroxypropionate), poly(3-hydroxybutyrate-co-3-hydroxyhexanoate), poly(3-hydroxybutyrate-co-3-hydroxyvalerate), and poly(3-hydroxybutyrate-co-4-hydroxybutyrate).

10. (canceled)

11. The granulated product according to claim 7, having a hardness of from 5 kgf to 35 kgf.

12. The granulated product according to claim 7, having a moisture content of 5% or less.
